(19) United States
(12) Patent Application Publication
(10) Pub. No.: US 2002/0159002 A1
(43) Pub. Date: Oct. 31, 2002

(54) Direct backlighting for liquid crystal displays

(75) Inventor: Chin Chang, Yorktown Heights, NY (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 09/823,768

(22) Filed: Mar. 30, 2001

(51) Int. Cl. G02F 1/1335

(52) U.S. Cl. 349/61

(57) ABSTRACT

A system and method for backlighting a liquid crystal display consisting of a planar array of uniformly distributed light emitting diodes (LEDs) with segmentation, each LED illuminating one or more colors of a picture element (pixel) or group of pixels. By controlling the current through each LED, infinite variations in intensity and color can be locally generated according to LCD addressing schemes and contents. High quality moving pictures can be generated by incorporating multiple row addressing and LED sequencing. The LED backlight addressing and driving method can be designed and synchronized with the LCD panel row and column driving scheme.

### FIELD OF THE INVENTION

This invention relates to the field of lighting of liquid crystal displays (LCDs), and more particularly to a method for direct background lighting and color mixing in LCDs.

### BACKGROUND OF THE INVENTION

To provide backlighting of a conventional liquid crystal display (LCD), a light source, such as a cold-cathode florescent lamp (CCFL), is typically placed at an edge of the LCD and oriented to direct the light to the LCD. This “side” lighting provides inexpensive contrast lighting for smaller LCDs. In these applications, color mixing is performed within the CCFL at the edge of the LCD, and then diffused into the panel.

Disadvantageously, this process is characterized by light losses and limited local area illumination capability. In larger LCD's, such as those required for consumer television applications, edge lighting cannot be satisfactorily used to provide needed scrolling backlighting for dynamic image quality improvement.

Heretofore, attempts at direct backlighting of LCD cells have been characterized by improving dynamic image quality with localized color mixing and optics design on the two-dimensional LCD screen at a group of individual pixel locations.

### SUMMARY

In a preferred embodiment of the present invention, a liquid crystal display (LCD) is backlit using an illumination source that consists of a planar array of uniformly distributed red, green, and blue (RGB) light emitting diodes (LEDs), each RGB light source unit illuminating a color filter area consisting of one or more picture element's (pixel) filter triads. By controlling the current through each LED unit, infinite variations in intensity and color points can be locally generated at the pixel or group of pixels location. Control of each RGB color element allows for color variations in major LCD driving directions electronically to provide a significant improvement in the optical quality of an image.

A computing device partitions the RGB backlight color cells of the LCD into pixel groupings and configurations according to a desired color property of an image. The RGB backlight cells are generated by using cyclic, rigid motion, and deformation transforms of a unit RGB cell. The ultimate size of RGB backlight cells in determined by the size of the LCD panel and the associated panel addressing schemes.

### BRIEF DESCRIPTION OF THE DRAWINGS

FIG. 1 shows a conventional liquid crystal display (LCD) using edge lighting.

FIG. 2 shows a preferred embodiment of LCD backlighting according to the present invention.

FIG. 3 shows an expanded perspective view of the lighting of a pixel or group of pixels according to the present invention.

FIG. 4 shows a circuit diagram of a preferred driver configuration for implementing the RGB LED based backlighting shown in FIGS. 2-3.

FIG. 5 shows a circuit diagram of a voltage regulator that can be used to control current rails of the LED columns.

FIG. 6 shows a circuit diagram of a voltage regulator that can be used to control current rails of the LED rows.

FIG. 7 shows an exemplary embodiment of an RGB cell structure for white color mixing in two dimensions.

FIG. 8 shows an alternate embodiment of an RGB cell structure and its cyclic transform and deformation.

FIG. 9 shows an exemplary embodiment of an extended RGB cell structure.

FIG. 10 shows an alternate embodiment of an extended RGB cell structure.

### DETAILED DESCRIPTION OF THE INVENTION

In a preferred embodiment of the present invention, an article of manufacture, i.e., a structure, is provided for directly backlighting a liquid crystal display (LCD) using a plurality of light emitting diodes (LED) that are physically located at an X-Y site location representing each picture element (pixel) or group of pixels of the display. While the invention can be adapted for monochrome LCD applications, the preferred adaptation is for color applications. In an LCD, color is created by linearly gating light from a source through a tricolor filter array of a liquid crystal (LC) medium via switching of LC cells. By grating appropriate mixtures of a white background light through red-green-blue (RGB) filters, each picture element (pixel) of the LCD can produce infinite variation in displayed color. See Gunter Wyszecki and W. S. Stiles “Color Science: Concepts and methods, quantitative data and formulae.”

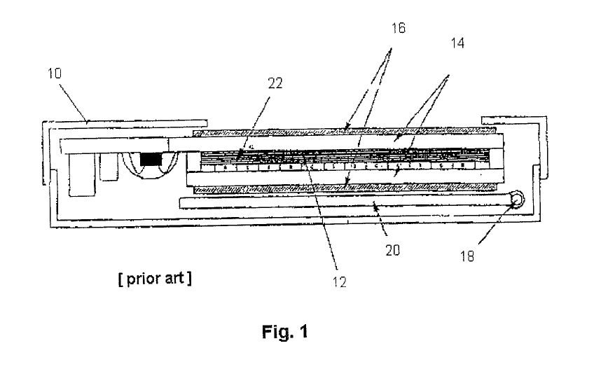

FIG. 1 shows a conventional dot matrix liquid crystal display (LCD) assembly 10 using edge lighting to provide lighting to liquid crystal (LC) structure 12 which is sandwiched between a pair of glass plates 14 and two optical polarizers 16. A cold-cathode florescent lamp (CCFL) 18 is coupled to LC structure 12 via an optical diffuser 20. Metering of the diffused light to the front of the display from diffuser 20 is provided by selectively switching the LC cells located next to individual color filters 22.

As is known in the art, an LC element 24 is activated by inducing a variable voltage across a specific X-Y location in element 24 via a pair of row and column arrays of parallel conductors, in order to change the state of the crystalline material between the conductors, thereby affecting the passage of light and creating an image at a pixel location when viewed from the front of LC element 24. Typical conductor implementations involve the deposition screening of the parallel conductors on separate thin glass plates and then sandwiching LC element 24 between those plates. Row and column drivers are then selectively activated in response to an electronic control signal to induce an appropriate voltage across selected pixel locations in LC element 24. Linear variations in the applied signal can then control the intensity of the light and color passing through the pixel cell.

LC panel cells in conventional embodiments are addressed using a method known as active addressing, wherein all rows are simultaneously driven using a set of orthogonal functions, such as Walsh functions. An alternative addressing method featuring reduced power at lower supply voltages in the LCDs uses a multiple-row addressing method, where the row and column voltages have the same voltage amplitude. In this method the number of rows that can be simultaneously addressed is equal to the square root of the number of rows in the LCD panel. For example, for a panel with N rows, there will be √N rows that can be simultaneously addressed in each addressing sequence, thus requiring √N addressing sequences to process a complete video screen.

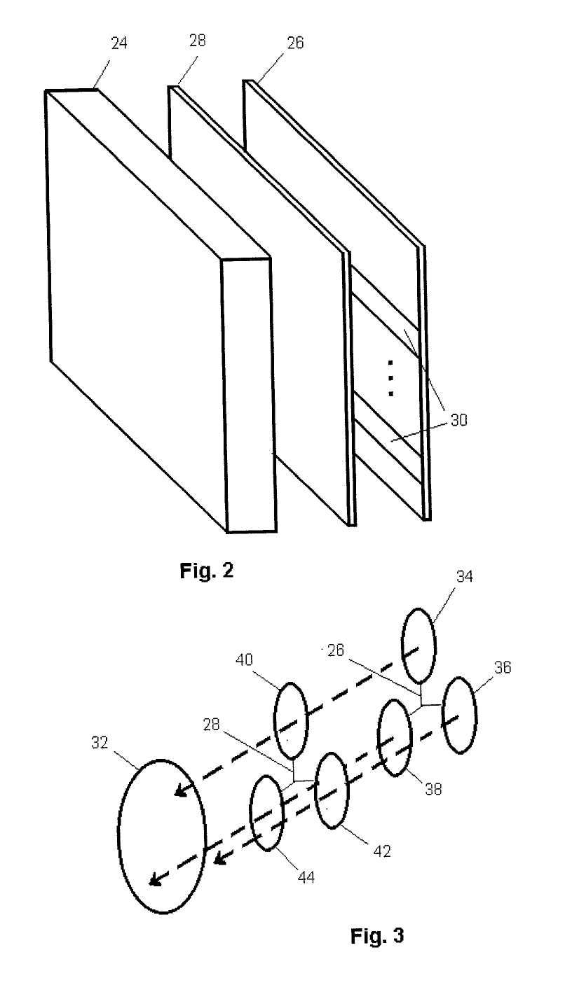

FIG. 2 shows a preferred embodiment of LCD direct backlighting according to the present invention. To provide an image with variations in color and intensity and provide improvement in dynamic images, a light source is placed directly to the rear of an LCD assembly. In a preferred embodiment of the present invention, this light source consists of a planar array of RGB light emitting diodes (LEDs) 26 in a spatial arrangement that is scaled to a same size as the front viewing area of LC element 24, and provides a triad of LEDs for each LCD pixel location or group of pixel locations. Intensity of light generated by each LED in LED array 26 can be controlled via an applied current in a manner that is governed by the equation

Iᵥ (I_{f} ,T)=Iᵥ (Iₜₑₛₜ. 25C)(1f ) e K(T-25C) [1]

where Iᵥ (I_{f},T) is the luminous intensity at LED forward current I_{f} and ambient temperature T, Iᵥ (Iₜₑₛₜ. 25C) is the data sheet luminous intensity at the forward current Iₜₑₛₜ and 25C, K is the temperature coefficient of the LED. A typical exemplary value for K in an exemplary AlInGaP is −0.010/C.

The light from each LED in array 26 is further directed through a planar waveguide 28 to provide a desired color mixing for a displayed image. The separation between the planes is artificially exaggerated in FIG. 2 for explanation purposes, since the preferred embodiment for the LED plane and LCD panel with color filters would be implemented as a glass panel serving as waveguide and color mixer.

LED plane 26 is divided into √N segments 30. As the LCD multiple rows are addressed in scrolling fashion, the LED plane segments 30 are also addressed (driven) synchronously. By doing so, the parasitic artifacts that are characteristic of fast moving pictures on an LCD screen can be effectively removed. By incorporating the two scrolling row processes in LCD and LED, the displayed image can have wide color range and wide luminance range without creating the artifacts.

FIG. 3 shows an expanded perspective view of the lighting of an individual pixel or group of pixels 32 according to the present invention. Each pixel or group of pixels 32 location of LC element 24 is spatially aligned with both a unique unit of LEDs 34, 36, and 38 within LED array 26 and a unique unit of RGB color filter cell locations 40, 42, and 44 through the color mixing waveguide 28. In a preferred embodiment, LEDs 34, 36, and 38 would be RGB-colored LEDs, thus eliminating the need for separate RGB cell locations next to waveguide 28.

In state of the art LED technology using an exemplary die size having a diameter of 6 mm, an individual high-brightness LED would be much larger than the cell size of an LCD pixel. Therefore, the unit RGB LED light source size would be much bigger that the LCD pixel size. Thus, each unit RGB is considered as corresponding to a pixel area on the LCD. However, it is anticipated that with miniaturization progress currently underway, this size restriction would not apply in the future, and that LEDs will be able to address a single color element of a pixel triad.

Thus, for an exemplary pixel area implementation, light from a unit LED cell consisting of cells 32, 24, and 36 is directly projected to the LCD element 24. This spatial arrangement is repeated throughout the whole LCD viewing area. Another improvement is to produce pictures directly on an LED panel without an LCD panel.

In the preferred embodiment, a unique signal can be applied to each LED unit to produce light variations from the LED according to equation [1]. Thus, each individual pixel or group of pixels 30 would be controlled with three distinct signals via each triad of LEDs. In response to these three unique excitation signals and the mixing of the light from each LED, a uniquely colored pixel area is generated. Although in the preferred embodiment, the excitation signals are provided in the analog domain, such signals can be generated in a digital domain, where On/Off duty cycle of the drive signals for each LED can be varied to produce an identical desired average light intensity. For example, a universal turn-on signal can be applied to a row of LED devices, and via column control for each LED current, each signal can be terminated at a pre-selected time and remain off for the remainder of a row scanning cycle period. This gives a time-averaging effect over the particular cycle. i.e. the longer on time the brighter the LED.

It will be appreciated that although the control of the luminous intensity of each pixel area is implemented via the applied currents in the LED triad in the above discussion, this was exemplary only, and not intended to restrict the scope of the present invention. Various alternative light metering methods and structures can be implemented to achieve an identical result, as are known to one skilled in the art.

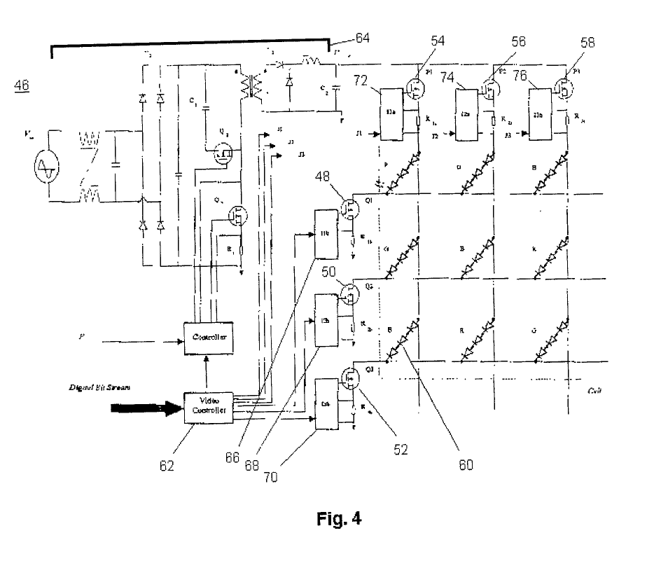

FIG. 4 shows a circuit diagram 46 of a preferred driver configuration for controlling the backlighting shown in FIGS. 2 and 3. A multitude of row drivers 48, 50, and 52 and a multitude of column drivers 54, 56, and 58 provide for the selective operation of unique LEDs in LED array 26. For example, by activating row driver 52 and column driver 54, led 60 is driven to produce a desired emitted light intensity based on control signals applied by video controller 62. As previously discussed, the drive method for varying the light intensity of a particular LED can use digital or analog drive techniques, and/or a combination of both.

There are many different driving patterns that can be employed to control light intensity in the LEDs of LED array 26 via row drivers 48, 50, and 52 and column drivers 54, 56, and 58. For example, by turning row drivers 48, 50, and 52 fully ‘on’ in a time-sequential manner and controlling column drivers 54, 56, and 58 with proper current ratios for color mixing, one can generate white color columns with preset color temperature and lumen output. Alternatively, by turning column drivers 54, 56, and 58 fully on in a time-sequential manner and controlling row drivers 48, 50, and 52 with proper current ratios, one can generate white color rows with preset color temperature and lumen output.

The time-sequential rate can be synchronized with a video frame rate and/or field rate of the image array. Moreover, by combining the control of row drivers 48, 50, and 52 and column drivers 54, 56, and 58 in a pair manner, such as the sequential activation of driver pairs 48, 54, or 56, 50, or 58, 52, one can generate white color diagonal. It should be noted that the exemplary forward power converter topology 64 shown in FIG. 4 is used only for illustration purpose, and should not be interpreted as restricting the scope of the invention. Many other similar power configurations can provide proper DC output can be suitable used.

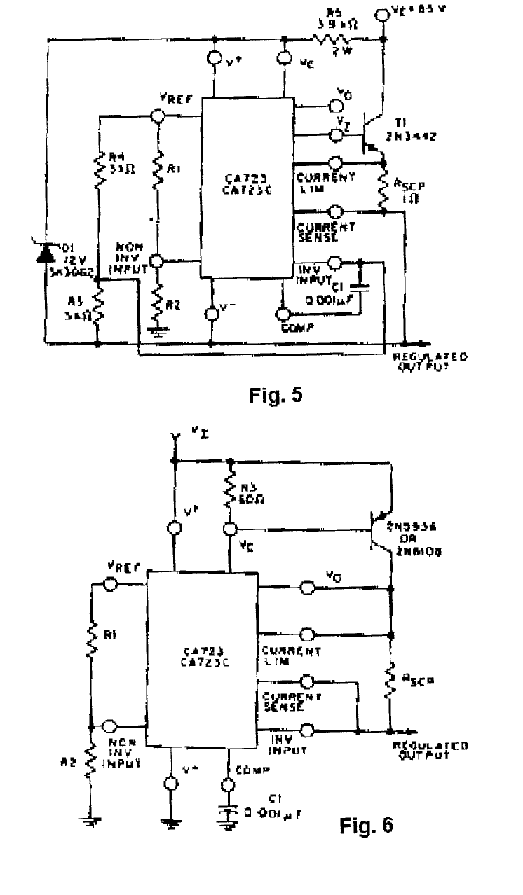

Row regulators 66, 68, and 70 provide a controlled voltage and/or current signal for the row elements, and column regulators 72, 74, and 76 provide a complementary voltage and/or current signal for the column elements. FIG. 5 shows an exemplary circuit diagram of a linear positive voltage regulator that can be used to control the current for column drivers 54, 56, and 58. An integrated linear regulator, such as the CA723, provide a controlled current that can provide the charge necessary to change the current in the LEDs in LED array 26. Similarly, FIG. 6 shows a circuit diagram of a positive voltage regulator that can be used to control current associated with row drivers 48, 50, and 52 using a different circuit configuration for the exemplary CA723.

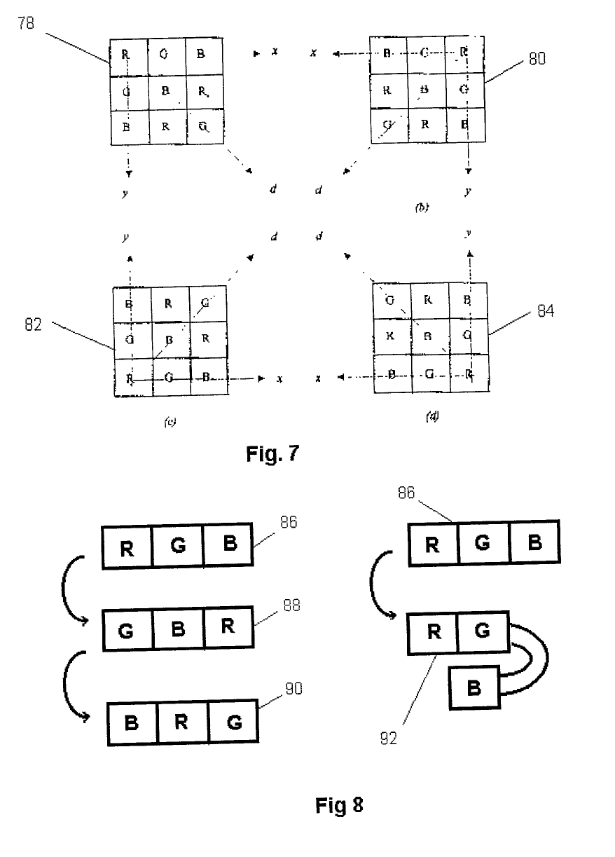

A significant advantage offered by such a distributed lighting source as shown in FIGS. 2 and 3 is the ability to configure the color points both structurally and electronically in a manner that optimizes the optical characteristics of a group of pixels. For example, image content sometimes “favors” one or more of horizontal, vertical, or diagonal color mixing configurations. For each of these applications, a particular spatial arrangement of RGB LED light sources in direct backlight configuration can be more uniquely suited for the presentation of this image over that of an edge-lit RGB arrangement. Some of the white color patterns that are possible based on the cell in FIG. 3 and its variations and extensions are shown in FIGS. 7-9. More importantly, when the RGB LED cells in FIGS. 7-9 are grouped and arranged in larger segments as shown in FIG. 2, the backlight control and scrolling signal can be coordinated with the LCD addressing signals to generate high quality moving pictures on the LCD screen.

FIG. 7 shows an exemplary embodiment of an RGB cell structure for white color mixing in two dimensions. In such a structure, color mixing can be performed along any desired axis. For example, an exemplary RGB cell 78 can be color mixed in any two-dimensional direction based on specific rigid motion transforms. RGB cell 80 demonstrates color mixing in the vertical direction. Similarly, RGB cells 82 and 84 demonstrate color mixing in the horizontal and a diagonal direction, respectively.

FIG. 8 shows an alternate embodiment of an RGB cell structure. Using cyclic transformations on a basic RGB cell 86, it can successively be transformed into RGB cell 88 and RGB cell 90. Alternatively, using a deformation transform, RGB cell 86 can be changed into RGB cell 92.

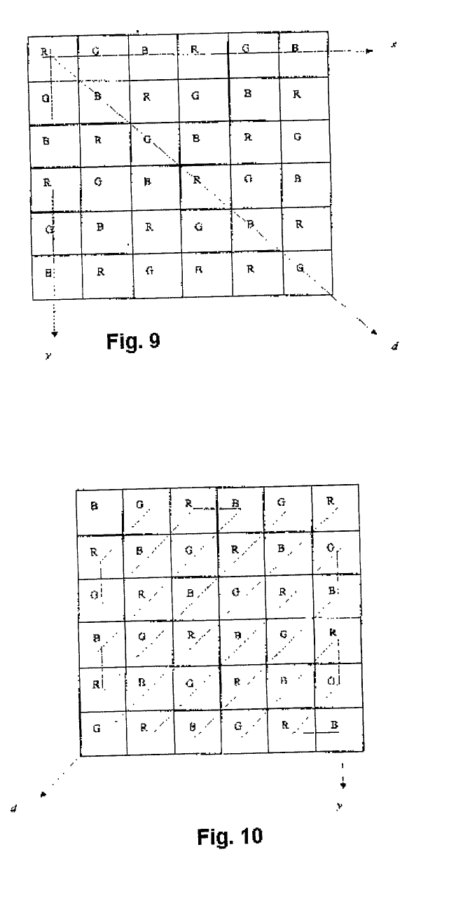

For larger LCDs, extensions of the basic RGB cells structures as shown in FIG. 8 can be created by duplicating the particular cell pattern in the x and y directions. This will increase the structure to fit the desired size of the LCD, while preserving a particular color-mixing property via rigid motion transforms of the diagram. FIG. 9 shows an exemplary embodiment of an extended LCD cell structure. Note that a particular sequence or pattern grouping is duplicated in both directions. A distinct advantage of direct backlighting having the configuration shown in FIG. 4 is that the number of current source driving channels only needs to be the total number of controllable rows and controllable columns.

FIG. 10 shows an alternate driving scheme embodiment of an extended LCD cell structure, having a zig-zag color mixing property. As shown in FIGS. 7 through 10, selection of a particular RGB configuration for a pixel area can be made electronically due to the ability to independently control each unique LED that is associated with each color cell of an RGB triad.

Numerous modifications to and alternative embodiments of the present invention will be apparent to those skilled in the art in view of the foregoing description. Accordingly, this description is to be construed as illustrative only and is for the purpose of teaching those skilled in the art the best mode of carrying out the invention. Details of the embodiments may be varied without departing from the spirit of the invention, and the exclusive use of all modifications which come within the scope of the appended claims is reserved.

What is claimed is:

1. A structure for providing lighting in a liquid crystal display (LCD) having a matrix arrangement of picture elements (pixels), comprising:
a generally flat liquid crystal (LC) element having a front display surface and a rear mounting surface;
a light source, which is mounted adjacent to said rear surface and oriented to direct light through said LC element in a direction orthogonal to said front surface;
a light intensity controlling means for controlling the light emitted from said light source; and
a color mixing means, which is mounted between the light source and the LC element.

2. The structure according to claim 1, wherein the light source comprises a plurality of light emitting diodes (LED).

3. The structure according to claim 2, wherein each one of the plurality of LEDs has a light emission color frequency that is selected from the group consisting of: red, green, and blue.

4. The structure according to claim 2, wherein the LEDs are arranged in a planar array.

5. The structure according to claim 4, wherein said planar array is additionally partitioned into RGB LED segments, which are configured electronically according to a predetermined color mixing property.

6. The structure according to claim 1, wherein the number of LED segments is determined by the number of rows of LCD panels.

7. The structure according to claim 5, wherein the color mixing property of each unit within said segment can be determined using a rigid motion transform.

8. The structure according to claim 5, wherein the color mixing property of each unit within said segment can be determined using a deformation transform.

9. The structure according to claim 2, wherein the plurality of LEDs are grouped in units, each unit being associated with an area comprising at least one pixel.

10. The structure according to claim 9, wherein said unit comprises at least one LED.

11. The structure according to claim 9, wherein said unit comprises three uniquely-colored LEDs.

12. The structure according to claim 2, wherein the light intensity controlling means comprises an electronic signal applied to each one of said plurality of LEDs.

13. The structure according to claim 12, wherein the electronic signal is governed by the equation:
$${I}_{v} ( {I}_{f} , T ) = {I}_{v} ( {I}_{test} \cdot 25 C ) ( \frac{{I}_{f}}{{I}_{test}} ) {e}^{K ( T - 25 C )} .$$

14. The structure according to claim 1, wherein the coloring mixing means comprises a waveguide.

15. A method for directly backlighting a liquid crystal display (LCD) having a plurality of picture element (pixel) areas and a plurality of light emitting diodes (LEDs) configured in a matrix arrangement, comprising the steps of:
a) loading a predetermined signal value in each one of a plurality of LED column drivers;
b) activating one of a plurality of LED row drivers;
c) activating all of a plurality of column LED drivers;
d) deactivating all row and column drivers;
e) repeating steps a) through d) for a next LCD row; and
f) repeating steps a) through e) in a cyclic manner.

16. The method according to claim 15, wherein the predetermined signal values are derived using an algorithm that incorporates at least one from the group consisting of: an LCD addressing signal in terms of signal frequency, signal row/column addressing, and signal amplitude.

17. The method according to claim 15, wherein the plurality of LEDs are grouped in units, each unit being associated with an area comprising at least one pixel.

18. The method according to claim 15, wherein said unit comprises at least one LED.

19. The structure according to claim 15, wherein said unit comprises three uniquely-colored LEDs.

20. The method according to claim 15, wherein each LED is associated with at least one color cell.

21. The method according to claim 15, wherein three color cells are associated with each pixel.

22. The method according to claim 15, where the color cells comprise at least one from a group consisting of: red, green, and blue.

23. The method according to claim 15, wherein the rows have a horizontal orientation and the columns have a vertical orientation.

24. The method according to claim 15, wherein the columns have a horizontal orientation and the rows have a vertical orientation.

25. A system for providing background lighting in a liquid crystal display (LCD) having a matrix of picture elements (pixels), comprising:
a liquid crystal (LC) element;
a planar array of light emitting diodes (LEDs) for illuminating said LC element;
at least one planar array of color cells for coloring the LED illumination;
an electronic controlling means; and
a power source.

26. The system according to claim 25, wherein each pixel is associated with three LEDs of the LED planar array.

27. The system according to claim 25, wherein the LEDs of the LED planar array are uniformly distributed horizontally and vertically in a spatial arrangement to align with pixels of the liquid crystal element.

28. The system according to claim 25, wherein the electronic controlling means comprises a predetermined driving means for activating one or more LEDs.
